(19) United States
(12) Patent Application Publication
(10) Pub. No.: US 2026/0056516 A1
(43) Pub. Date: Feb. 26, 2026

(54) MODEL OPTIMIZATION USING MACHINE LEARNING

(71) Applicant: Schlumberger Technology Corporation, Sugar Land, TX (US)

(72) Inventors: Dinesh Sonu Dabholkar, Pune (IN); Walter Romaric Elingou, Pointe-Noire (CG)

(21) Appl. No.: 18/813,294

(22) Filed: Aug. 23, 2024

(51) Int. Cl. G05B 13/02

(52) U.S. Cl. CPC G05B 13/027

(57) ABSTRACT

The present disclosure relates to systems and methods for automated model calibration. The systems and methods continuously track a model status of a production model deployed in a production environment and suggests calibration parameters in real time for the production model in response to changes in the production environment. The systems and methods use model outputs and field observations to calibrate the production model.

### BACKGROUND OF THE DISCLOSURE

Wellbores are commonly drilled from a surface location or seabed for various exploration and extraction activities. These wellbores are used to access and extract fluid resources like liquid and gaseous hydrocarbons from subterranean formations. The construction of wellbores involves the use of earth-boring equipment such as drill bits for initial drilling and reamers for enlarging the wellbore diameters.

Digital solutions such as digital twin of the field have been popular among field operators as they provide actionable insights to operators which can be used for production optimization, troubleshooting, as well mitigating various operational and production challenges. Typically, digital solutions use physics-based models as a core foundation. For the models to be reliable, the models need to be always calibrated to field conditions.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

Some implementations relate to a method. The method includes receiving an indication that a model deviation occurred in a behavior of a production model running in a production environment. The method includes triggering, in response to the model deviation occurring, a reinforcement machine learning model to modify training parameters of a surrogate model that is a proxy of the production model. The method includes receiving values for calibration parameters identified by the reinforcement machine learning model that cause a reduction in the model deviation, wherein the calibration parameters correspond to the modified training parameters of the surrogate model. The method includes providing the calibration parameters to the production model.

Some implementations relate to a system. The system includes a memory to store data and instructions; and a processor operable to communicate with the memory, wherein the processor is operable to: receive an indication that a model deviation occurred in a behavior of a production model running in a production environment; trigger, in response to the model deviation occurring, a reinforcement machine learning model to modify training parameters of a surrogate model that is a proxy of the production model; receive values for calibration parameters identified by the reinforcement machine learning model that cause a reduction in the model deviation, wherein the calibration parameters correspond to the modified training parameters of the surrogate model; and provide the calibration parameters to the production model.

Some implementations relate to a computer-readable storage medium including instructions that, when executed by a processor, cause the processor to: receive an indication that a model deviation occurred in a behavior of a production model running in a production environment; trigger, in response to the model deviation occurring, a reinforcement machine learning model to modify training parameters of a surrogate model that is a proxy of the production model; receive values for calibration parameters identified by the reinforcement machine learning model that cause a reduction in the model deviation, wherein the calibration parameters correspond to the modified training parameters of the surrogate model; and provide the calibration parameters to the production model.

Additional features and aspects of implementations of the disclosure will be set forth herein, and in part will be obvious from the description, or may be learned by the practice of such implementations. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is an example of a downhole system in accordance with implementations of the present disclosure.

FIG. 2 illustrates an example environment for a production management system using a production model in accordance with implementations of the present disclosure.

FIG. 3 illustrates an example environment of a production management system in communication with a reinforcement learning system in accordance with implementations of the present disclosure.

FIG. 4 illustrates an example environment of a reinforcement learning system in communication with a product management system, a surrogate module, and an anomaly detection module in accordance with implementations of the present disclosure.

FIG. 5 illustrates example graphical user interfaces (GUIs) of a model deviation and suggested calibration parameters in accordance with implementations of the present disclosure.

FIG. 6 illustrates an example method for automated model calibration in accordance with implementations of the present disclosure.

FIG. 7 illustrates components that may be included within a computer system.

### DETAILED DESCRIPTION

This disclosure generally relates to systems and methods for optimizing models with continuously changing parameters. Digital solutions such as digital twin of the field have been popular among field operators as they provide actionable insights to operators which can be used for production optimization, troubleshooting, as well mitigating various operational and production challenges. Typically, digital solutions use physics-based models as a core foundation. For the models to be reliable, the models need to be always calibrated to field conditions because oilfields are depleting continuously. The state of the field is continuously changing and there is a need for updating the model parameters.

The systems and methods provide real-time predictions on actions to take to automate and accelerate the process of model calibration. As will be discussed in further detail below, the present disclosure includes a number of practical applications having features described herein that provide benefits and/or solve problems associated with a production management system using production models for which model calibration is required. Some example benefits are discussed herein in connection with various features and functionalities provided by a production management system using production models implemented on one or more computing devices. It will be appreciated that benefits explicitly discussed in connection with one or more implementations described herein are provided by way of example and are not intended to be an exhaustive list of all possible benefits of the wellbore extraction tool. For example, one benefit includes providing a significant reduction of time and effort required for fine tuning model calibration parameters. Another example benefit includes minimizing human intervention that leads to human error reduction. Another example benefit includes automating monitoring production flow behavior (normal/unstable flow, water breakthrough from reservoir, slugging in pipelines, etc.). The end user benefits from a simplified interface that depicts the prediction results along with a model's confidence interval. In some implementations, the user can take necessary actions based on these suggestions.

The systems and methods include a production management system that uses a production model for which model parameters refinement is required. The systems and methods include a reinforcement learning module that interacts with the production management system to continuously track the model deviation of the production model as compared to the current field conditions. The reinforcement learning module passes any model deviations detected to a surrogate model, which is a proxy model of the production model. The surrogate model stores quasi-steady state behavior of the production model. The surrogate model supplements an offline version of the production management system environment to a reinforcement machine learning model which enables accelerated training process of the reinforcement machine learning model to determine which parameters of the production model to calibrate and suggested values for the calibration parameters. The systems and methods continuously track a model status of the production model and suggests calibration parameters in real time for production models deployed in a production environment. The systems and methods use model outputs and field observations to calibrate the production model.

The systems and methods automate the monitoring of the production flow behavior (normal/unstable flow, water breakthrough from reservoir, slugging in pipelines, etc.). The system and methods include an anomaly detection module that identifies any anomalies in the production environment providing actionable insights on the detected anomalies. In some implementations, the reinforcement machine learning model identifies suggested values for calibrations parameters in response to the detected anomaly.

In some implementations, the systems and methods automatically apply the suggested values for the calibration parameters to the production model to modify a behavior of the production model in the production environment. In some implementations, the systems and methods display the suggested values to a user to use in modifying the production model or the production environment.

The systems and methods may be used for solving a variety of optimization challenges in production environments. One example use case of using the systems and methods includes real-time optimization of gas lift injection rates in complex production network. Additional examples of using the systems and methods include automatic optimization of chemical injection in the field and maximizing field production through automated optimization of field conditions.

One of the technical advantages of the systems and methods of the present disclosure is accelerating the training process of model calibration. The systems and methods use a surrogate model that supplements an offline version of the production management system environment which enables accelerated training of the reinforcement machine learning model in selecting calibration parameters for the production model. Another technical advantage of the systems and methods of the present disclosure is providing real-time predictions on actions to take to calibrate the model. The systems and methods provide calibration parameters to the production model in the production environment in real time in response to a current state of the production model. Another technical advantage of the systems and methods of the present disclosure is reducing the time required for fine tuning model calibration parameters. Another technical advantage of the systems and methods of the present disclosure is automating the monitoring of production flow behaviors. The systems and methods of the present disclosure provide a notification in response to detecting an anomaly providing actionable insights for the detected anomaly.

The systems and methods optimize the challenges of the production environment and benefit the user by providing a significant reduction of time and effort required for fine tuning model calibration parameters. The systems and methods minimize human intervention that leads to human error reduction and the end user benefits from a simplified interface that depicts the prediction results along with a model's confidence interval. In some implementations, the user can take necessary actions based on these suggestions. In some implementations, the actions are automatically applied to the model.

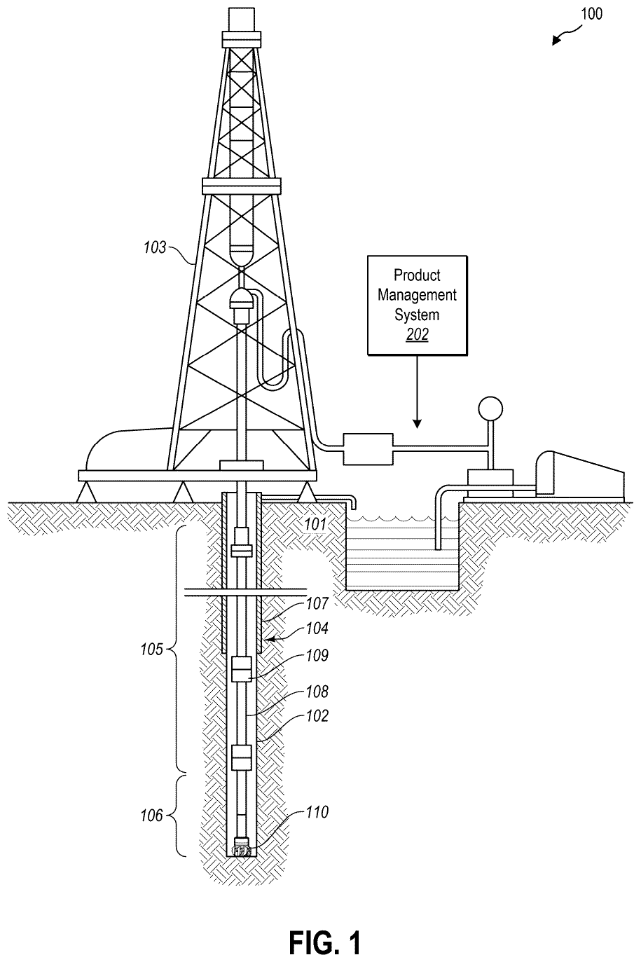

Additional details will now be provided regarding systems described herein in relation to illustrative figures portraying example implementations. For example, FIG. 1 shows one example of a downhole system 100 for drilling an earth formation 101 to form a wellbore 102. The downhole system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some implementations, the drill string 105 further includes additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing.

In general, the downhole system 100 may include other downhole drilling tools, components, and accessories such as special valves (e.g., kelly cocks, blowout preventers, and safety valves). Additional components included in the downhole system 100 may be considered a part of the drilling tool assembly 104, the drill string 105, or a part of the BHA 106, depending on their locations in the downhole system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other implementations, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface 111 or may be allowed to fall downhole. The bit 110 may include one or more cutting elements for degrading the earth formation 101.

The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as one or more of gravity, magnetic north, or true north. Using measurements obtained with the geostationary position, the RSS may locate the bit 110, change the course of the bit 110, and direct the directional drilling tools on a projected trajectory. The RSS may steer the bit 110 in accordance with or based on a trajectory for the bit 110. For example, a trajectory may be determined for directing the bit 110 toward one or more subterranean targets such as an oil or gas reservoir.

The downhole system 100 may include or may be associated with a production management system 202. In some implementations, the production management system 202 is on a remote server in communication with the downhole system 100 via a network. The production management system 202 facilitates users with managing operations of the downhole system 100.

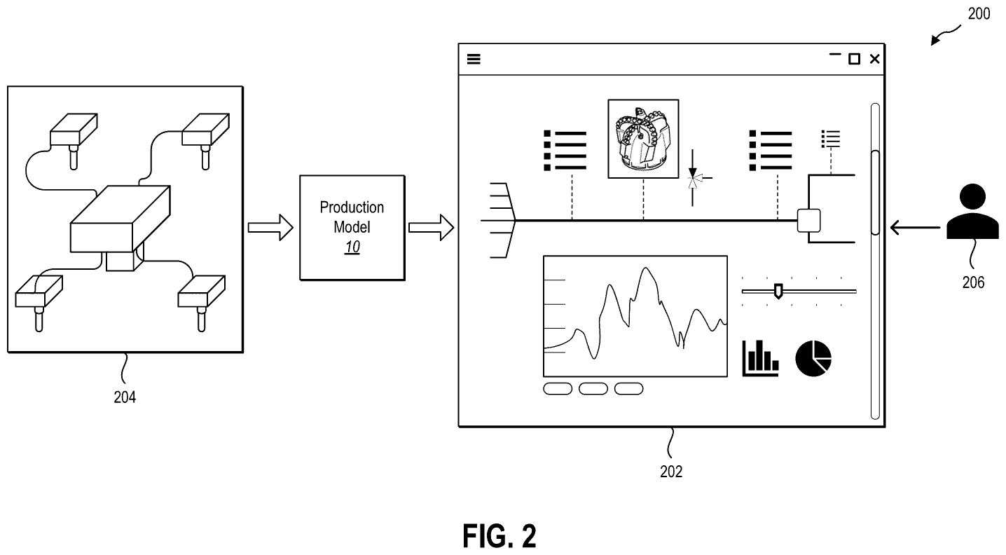

FIG. 2 illustrates an example environment 200 for a production management system 202 using a production model 10. The production management system 202 uses the production model 10 to ingest live field data of a field 204 and provide valuable insights to a user 206 of the production management system 202. In some implementations, the field 204 is the downhole system 100 (FIG. 1). The production model 10 simulates the transient behavior of field (reservoir to surface facilities) and advises the optimized model parameters that can be implemented in the field. In some implementations, the production model 10 is used for production optimization, troubleshooting, as well mitigating various operational and production challenges. In some implementations, the production model 10 is a physics-based model. While one production model 10 is illustrated, it should be appreciated that a plurality of production models may be in communication with the production management system 202.

In some implementations, the production model 10 is running in a production environment in the field 204 and the production management system 202 is on a server in communication with the production model 10 through a network. In some implementations, the production management system 202 is on a cloud server remote from the production model 10 accessed through the network. The production management system 202 is hosted on virtual machines in the cloud. In some implementations, the production management system 202 is on an edge device at the field 204.

The network may include one or multiple networks and may use one or more communication platforms and/or technologies suitable for transmitting data. The network may refer to any data link that enables transport of electronic data between devices of the environment 200. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. The server may include one or more computing devices (e.g., including processing units, data storage, etc.) organized in an architecture with various network interfaces for connecting to and providing data management and distribution across one or more client systems.

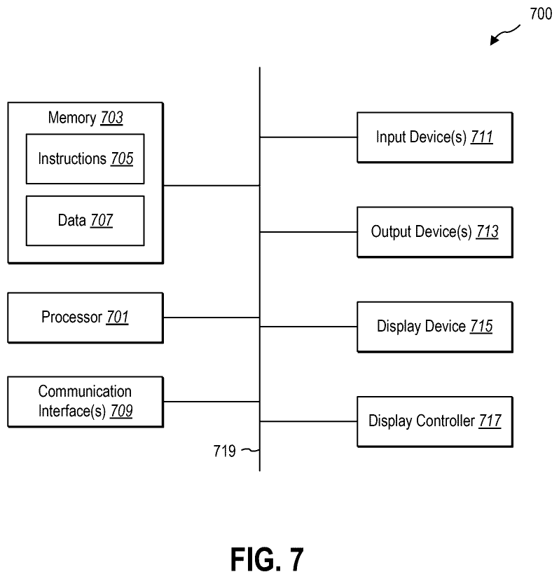

In some implementations, the user 206 accesses the production management system 202 using a client device. The client device may be representative of one or multiple client devices and may refer to various types of computing devices. For example, the client device may include a mobile device such as a mobile telephone, a smartphone, a personal digital assistant (PDA), a tablet, a laptop, or any other portable device. Additionally, or alternatively, the client device may include one or more non-mobile devices such as a desktop computer, server device, surface or downhole processor or computer (e.g., associated with a sensor, system, or function of the downhole system), or other non-portable device. In one or more implementations, the client device includes a graphical user interface (GUI) thereon (e.g., a screen of a mobile device). In addition, or as an alternative, one or more of the client devices may be communicatively coupled (e.g., wired or wirelessly) to a display having the GUI thereon for providing a display of system content. The server may similarly refer to various types of computing devices. Each of the devices of the environment 200 may include features and/or functionalities described below in connection with FIG. 7.

The production model 10 includes a plurality of parameters and values for the parameters. The conditions of the field 204 are constantly changing and values of the parameters may need to be calibrated to match the changing conditions of the field 204. The values of the parameters are calibrated to the conditions of the field 204.

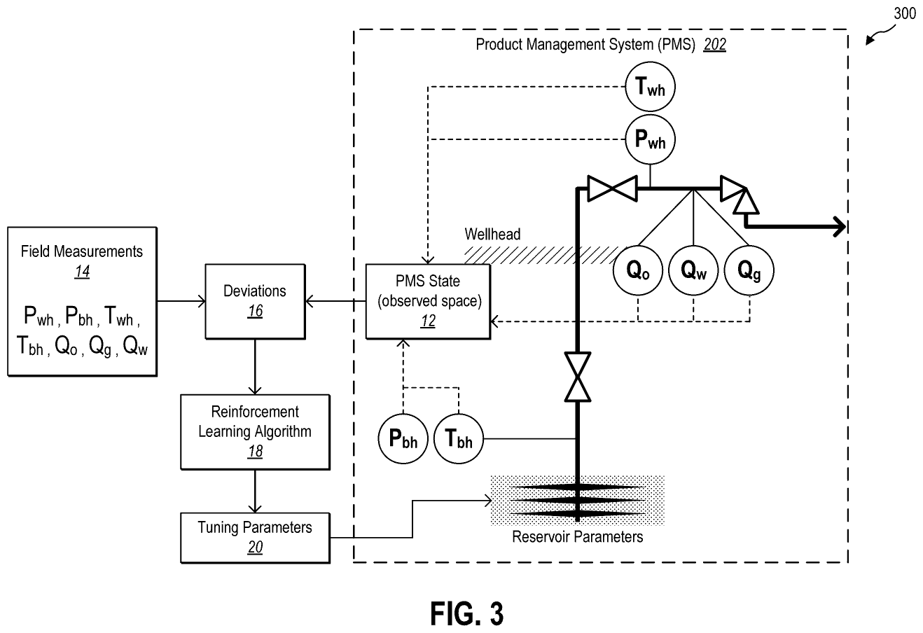

FIG. 3 illustrates an example environment 300 with the production management system 202 in communication with a reinforcement learning system 302 that provides the calibration parameters 20 for the production model 10 (FIG. 2). The tuning parameters (e.g., the calibration parameters 20) are values of parameters that the reinforcement learning system 302 changes to match the changing field condition.

The production management system 202 observes the model status 12 of the production model 10 (FIG. 2) and the field measurements 14 of the real-time field data of the field 204 (FIG. 2). In some implementations, the field measurements 14 include bottomhole pressure (P_{bh}), wellhead pressure (P_{wh}), bottomhole temperature (T_{bh}), wellhead temperature (T_{wh}), oil flowrate (Qₒ), gas flowrate (Q_{g}), and water flowrate (Q_{w}). In some implementations, the reservoir parameters include the gas to oil ratio (GOR), the reservoir pressure (P_{Res}), and the watercut (WC). The production management system 202 continuously tracks the model status 12 and provides the model status 12 and the field measurements 14 to the reinforcement learning system 302. In some implementations, the production management system 202 identifies model parameters and sends values of the model parameters to the reinforcement learning system 302 as the model status 12.

The reinforcement learning system 302 receives the live field data (the field measurements 14) and a current model status 12 of the production model 10. The reinforcement learning system 302 compares the model status 12 to the field measurements 14. The reinforcement learning system 302 identifies a model deviation 16 in response to identifying a change in behavior of the production model 10 by comparing the model status 12 to the field measurements 14. In some implementations, the reinforcement learning system 302 identifies parameters of the production model 10 and compares values of the parameters to a threshold value. The reinforcement learning system 302 continues to monitor the model status 12 and the field measurements 14 in response to the parameters remaining below the threshold value. In some implementations, the reinforcement learning system 302 tracks all parameters of the production model 10 and compares the value of the parameters to the threshold value. The reinforcement learning system 302 determines that a model deviation 16 occurred in response to the value of the parameters exceeding the threshold value.

The reinforcement learning system 302 includes a reinforcement machine learning model 18 that is triggered in response to receiving an indication that the model deviation 16 occurred in the production model 10. In some implementations, the reinforcement machine learning model 18 is a deep neural network. The reinforcement machine learning model 18 identifies calibration parameters 20 to provide to the production management system 202 with new values for the production model 10 to minimize the error between the model prediction and the field measurement. The reinforcement learning system 302 provides real time suggestions for values of the calibration parameters 20 in response to the changing field conditions (e.g., the changing field measurements 14). The reinforcement learning system 302 uses the production model output and field observations to calibrate the production model 10 allowing for corrections to occur in response to any identified model deviations 16 in real time.

In some implementations, the production management system 202 automatically modifies parameters of the production model 10 to values provided in the calibration parameters 20. In some implementations, the production management system 202 displays the calibration parameters to the user 206 (FIG. 2), for example, on a graphical user interface of a display on a client device of the user 206.

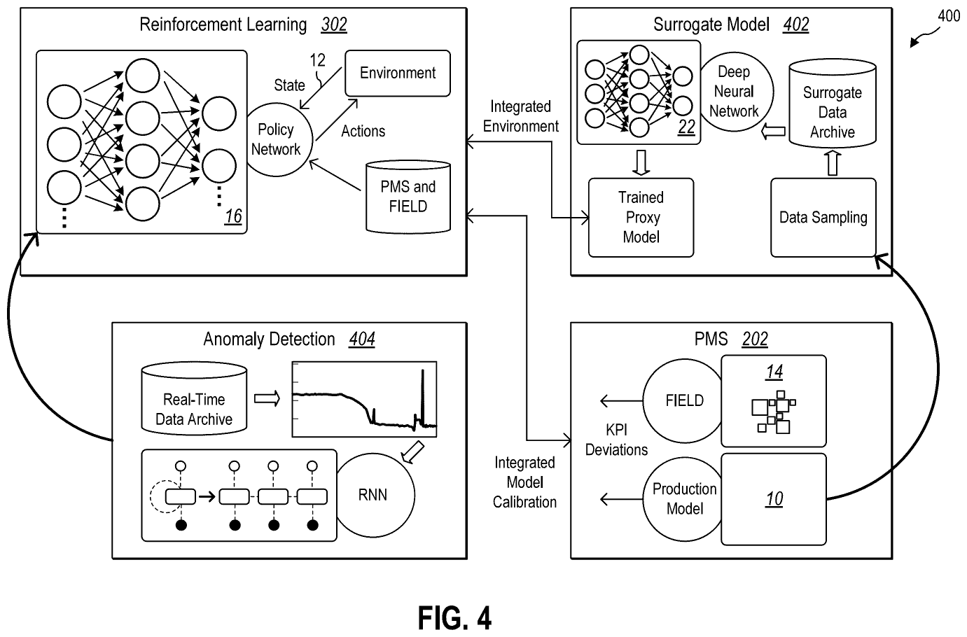

FIG. 4 illustrates an example environment 400 with the reinforcement learning system 302 in communication with the production management system 202, a surrogate module 402, and an anomaly detection module 404. In some implementations, the reinforcement learning system 302 passes the information received from the production management system 202 (a current model status 12 and the real time field measurements 14) to the surrogate module 402. The surrogate module 402 supplements an offline version of the production environment to the reinforcement learning system 302 which enables an accelerated training process of the reinforcement learning system 302.

The surrogate module 402 includes a surrogate model 22 that is a proxy model of the production model 10 and stores quasi-steady state behavior of the production model 10. The surrogate model 22 simulates the production model 10 in the production environment. In some implementations, the surrogate model 22 is a machine learning model trained on various model behaviors of the production model 10. One example of the machine learning model is a deep neural network (DNN). The data from the parameters of the production model 10 is collected from the production model 10 and stored in the memory of the machine learning model. The surrogate model 22 learns from the observations of the production model 10. In some implementations, the data ingestion is automated from the production management system 202 through data extraction and ingestion pipelines.

The surrogate module 402 receives the data (e.g., the values of the parameters of the production model 10) and performs a surrogate data preparation on the data. In some implementations, the data is received from thousands of parameters of the production model 10 over a time period. The surrogate module 402 identifies the values of the parameters and stores the values of the parameters in the memory of the surrogate model 22. The surrogate model 22 stores the quasi-steady state behavior of the production model 10. The surrogate model 22 uses the values of the parameters to learn the behavior of the production model 10 in the production environment.

The reinforcement machine learning model 18 uses the surrogate model 22 to correct any identified model deviations 16 that occurred in the production model 10 (e.g., the value of the parameters of the production model 10 exceeded a threshold). The reinforcement machine learning model 18 uses the surrogate model 22 to identify calibration parameters 20 to modify a behavior of the production model 10 and minimize the model deviations 16. In some implementations, the reinforcement machine learning model 18 tunes values of training parameters of the surrogate model 22 until the behavior of the surrogate model 22 reduces the model deviation 16. For example, the reinforcement machine learning model 18 tunes the values of the training parameters to match the live field measurements 14. Upon the tuning process completing, the reinforcement machine learning model 18 identifies suggested values for the calibration parameters 20 based on the values of the training parameters.

Interacting with the surrogate model 22, allows the reinforcement machine learning model 18 to modify training parameters of the surrogate model 22 offline from the production environment to determine suggested values of the calibration parameters 20 to provide to the production model 10. The surrogate model 22 provides an opportunity to tune the calibration parameters 20 allowing the reinforcement machine learning model 18 to simulate modifications to the production environment without interacting with the production environment.

The reinforcement learning system 302 provides the calibration parameters 20 and the new values for the calibration parameters 20 to the project management system 202 in response to the reinforcement machine learning model 18 identifying that tuning process of the calibration parameters 20 is complete. In some implementations, the project management system 202 automatically updates the values of the parameters of the production model 10 to match the values of the calibration parameters 20 suggested by the reinforcement machine learning model 18.

In some implementations, the reinforcement machine learning model 18 is triggered in response to an anomaly being detected by the anomaly detection module 404. The anomaly detection module 404 monitors the production flow behavior of the production environment for any anomalies. An anomaly is an abnormal behavior of the production environment. For example, an unusual or out of the ordinary behavior. One example anomaly in the production environment is an increase in water from the reservoirs. Another example anomaly in the production environment is unstable flow. Another example anomaly in the production environment is slugging in the pipelines. Another example anomaly in the production environment is water breakthrough from a reservoir.

The anomaly detection model 404 receives the field measurements 14 from the production management system 202 and monitors the field measurements 14 for a change in condition. In some implementations, the anomaly detection module 404 includes a reinforcement machine learning algorithm that monitors the production flow behavior and identifies the anomaly occurring (e.g., a change in condition) in response to the monitoring of the production flow. The anomaly detection module 404 sends a signal to the reinforcement machine learning model 18 identifying the anomaly that is occurring in the production environment.

The reinforcement machine learning model 18 identifies calibration parameters 20 and suggested values of the calibration parameters 20 to change a behavior of the production model 10 in response to the detected anomaly. The reinforcement machine learning model 18 sends the calibration parameters 20 and the detected anomaly to the project management system 202.

In some implementations, the project management system 202 displays the calibration parameters 20 and the values suggested by the reinforcement machine learning model 18 on a GUI of a display. The user 206 benefits from a simplified interface that depicts the prediction results along with a confidence interval of the reinforcement machine learning model 18. The user 206 can take necessary actions based on these suggestions. For example, the user 206 accepts the values suggested by the reinforcement machine learning model 18 and modify the production model 10. Another example includes the user 206 modifies the values suggested by the reinforcement machine learning model 18 prior to making the changes in the production model 10.

The environment 400 provides real-time predictions on actions to take for model calibration. The environment 400 automates and accelerates the model calibration process reducing the time and effort required for fine tuning model calibration parameters and minimizes human intervention.

In some implementations, one or more computing devices (e.g., servers and/or devices) are used to perform the processing of the environment 400. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the production management system 202, the reinforcement learning system 302, the surrogate module 402, and the anomaly detection module 404 are implemented on a single computing device. Moreover, in some implementations, one or more subcomponent of the feature and functionalities discussed herein may be implemented are processed on different server devices of the same or different cloud computing networks. For example, the production management system 202, the reinforcement learning system 302, the surrogate module 402, and the anomaly detection module 404 are implemented on different server devices. In this way, the environment 400 may be a cloud computing environment, and the production management system 202, the reinforcement learning system 302, the surrogate module 402, and the anomaly detection module 404 may be implemented across one or more devices of the cloud computing environment in order to leverage the processing capabilities, memory capabilities, connectivity, speed, etc., that such cloud computing environments offer in order to facilitate the features and functionalities described herein.

In some implementations, each of the components of the environment 400 is in communication with each other using any suitable communication technologies. In addition, while the components of the environment 400 are shown to be separate, any of the components or subcomponents may be combined into fewer components, such as into a single component, or divided into more components as may serve a particular implementation. In some implementations, the components of the environment 400 include hardware, software, or both. For example, the components of the environment 400 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 400 include hardware, such as a special purpose processing device to perform a certain function or group of functions. In some implementations, the components of the environment 400 include a combination of computer-executable instructions and hardware.

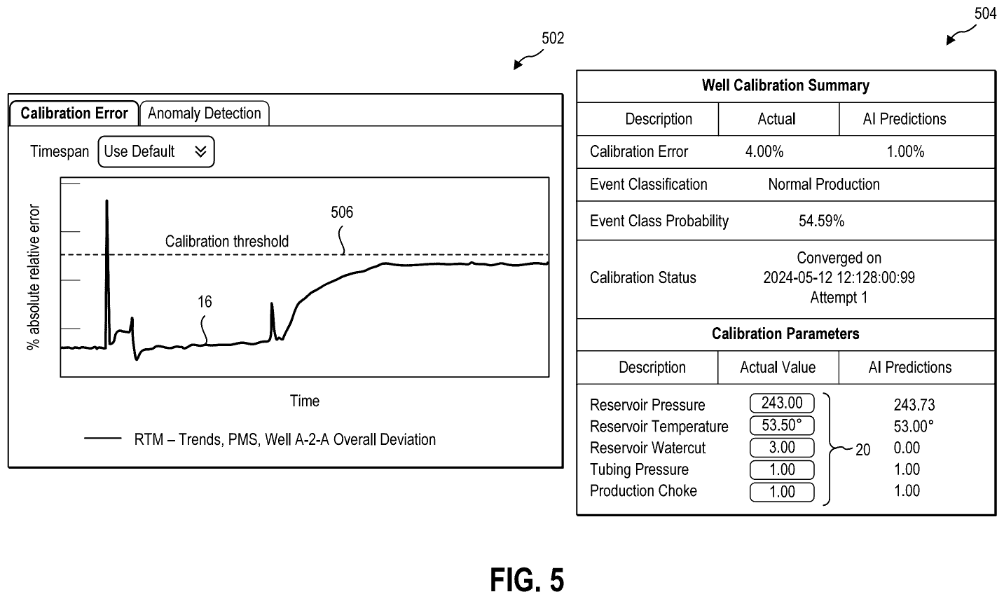

FIG. 5 illustrates an example GUI 502 of a model deviation 16 of a production model 10 (FIG. 4) and an example GUI 504 of suggested values for the calibration parameters 20 to reduce the model deviation 16 in the GUI 502. The GUI 502 illustrates an example threshold 506 that the value of the parameters of the production model 10 exceeded to trigger an indication of the model deviation 16 occurring in the production model 10.

The GUI 502 and the GUI 504 are presented in the production management system 202 (FIG. 4) in response to the reinforcement learning system 302 (FIG. 4) identifying that the model deviation 16 occurred with the suggested values determined by the reinforcement machine learning model 18 for the calibration parameters 20. The GUI 504 provides a summary of the current deviation occurring in the production model 10 and any predicted deviations that may occur by the production model 10. The GUI 504 also provides an anomaly classification (normal, abnormal) and any detected anomalies in the production environment. The GUI 504 may also provide a confidence level of the predictions.

In some implementations, the user 206 accepts the suggested values for the calibration parameters 20 and the GUI 502 shows the values of the parameters of the production model 10 moving below the threshold value 506 reducing the model deviation 16. In some implementations, the suggested values are automatically accepted by the production management system 202 and the GUI 502 shows the values of the parameters of the production model 10 moving below the threshold value 506 in response to accepting the suggested values of the calibration parameters 20.

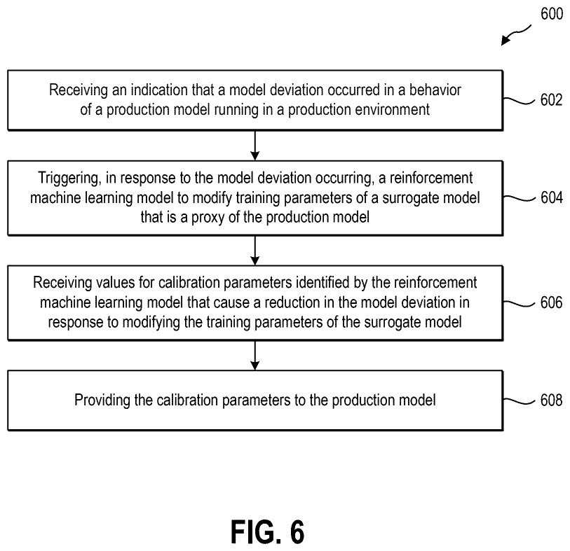

FIG. 6 illustrates an example method 600 for automated model calibration. The actions of the method 600 are discussed below in reference to FIGS. 1-5.

At 602, the method 600 includes receiving an indication that a model deviation occurred in a behavior of a production model running in a production environment. In some implementations, the reinforcement learning system 302 receives an indication that the model deviation 16 occurred. In some implementations, the reinforcement learning system 302 continuously receives real time field measurements 14 of the production environment (e.g., the field 204) and continuously receives values of parameters of the production model 10. In some implementations, the reinforcement learning system 302 identifies the model deviation 16 occurred by comparing the values of the parameters of the production model 10 to a threshold value and determining the model deviation 16 occurred in response to the parameters exceeding the threshold value.

At 604, the method 600 includes triggering, in response to the model deviation occurring, a reinforcement machine learning model to modify training parameters of a surrogate model that is a proxy of the production model. The reinforcement learning system 302 triggers a reinforcement machine learning model 18 to modify training parameters of the surrogate model 22 in response to the model deviation 16 occurring. The surrogate model 22 is a proxy of the production model 10. In some implementations, the surrogate model 22 is a deep neural network machine learning model. The surrogate model 22 is trained on parameters of the production model 10 collected over time to learn a behavior of the production model 10 in the production environment.

In some implementations, the reinforcement machine learning model 18 tunes values of training parameters of the surrogate model 22 until the behavior of the surrogate model 22 reduces the model deviation 16. For example, the reinforcement machine learning model 18 tunes the values of the training parameters to match the live field measurements 14. Upon the tuning process completing, the reinforcement machine learning model 18 identifies suggested values for the calibration parameters 20 based on the values of the training parameters.

In some implementations, the reinforcement machine learning model receives an indication that an anomaly occurred in the production environment. The reinforcement machine learning model 18 modifies training parameters of a surrogate model 22 in response to the anomaly occurring. In some implementations, the anomaly is a different condition than an expected condition in the production environment.

At 606, the method 600 includes receiving values for calibration parameters identified by the reinforcement machine learning model that cause a reduction in the model deviation. In some implementations, the calibration parameters 20 correspond to the modified training parameters of the surrogate model 22. The reinforcement learning system 202 receives the values for the calibration parameters 20 from the reinforcement machine learning model 18. In some implementations, the calibration parameters 20 provide values to modify a behavior of the production model 10 to decrease the model deviations 16. In some implementations, the calibration parameters 20 provide values to modify a behavior of the production model 10 to decrease the anomaly.

At 608, the method 600 includes providing the calibration parameters to the production model. The reinforcement learning system 302 provides the calibration parameters 20 to the production management system 202. In some implementations, the production management system 202 automatically modifies values of parameters of the production model 10 to correspond to the values of the calibration parameters 20. In some implementations, the production management system 202 presents, on a display, the values for the calibration parameters 20 for the production model 10 and a confidence level of the values for reducing the model deviation 16. For example, the production management system 202 modifies the values of parameters of the production model 10 in response to receiving a selection of the calibration parameters 20 from a user 206.

The method 600 automates model calibration by continuously tracking parameters of the production model 10 deployed in a production environment and suggesting calibration parameters in real time to modify a behavior of the production model 10 in response to changes in the production environment.

Turning now to FIG. 7, this figure illustrates certain components that may be included within a computer system 700. One or more computer systems 700 may be used to implement the various devices, components, and systems described herein.

The computer system 700 includes a processor 701. The processor 701 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, implementation of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of implementations of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 709 may connect the computer system 700 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with implementations disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into one or more of text, graphics, or moving images (as appropriate) shown on the display device 715.

The various components of the computer system 700 may be coupled together by one or more buses, which may include one or more of a power bus, a control signal bus, a status signal bus, a data bus, other similar components, or combinations thereof. For the sake of clarity, the various buses are illustrated in FIG. 7 as a bus system 719.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶ [0014]-[0074] includes various implementations that, where feasible, may be combined in any permutation. For example, the implementation of ¶¶ [0014]-[0074] may be combined with any or all implementations of the following paragraphs. Implementations that describe acts of a method may be combined with implementations that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some implementations, a method includes receiving an indication that a model deviation occurred in a behavior of a production model running in a production environment. The method includes triggering, in response to the model deviation occurring, a reinforcement machine learning model to modify training parameters of a surrogate model that is a proxy of the production model. The method includes receiving values for calibration parameters identified by the reinforcement machine learning model that cause a reduction in the model deviation, wherein the calibration parameters correspond to the modified training parameters of the surrogate model. The method includes providing the calibration parameters to the production model.

In some implementations, the method includes automatically modifying values of parameters of the production model to correspond to the values of the calibration parameters.

In some implementations, the method includes presenting, on a display, the calibration parameters for the production model; and modifying the values of parameters of the production model in response to receiving a selection of the calibration parameters from a user.

In some implementations, the method includes continuously receiving real time field measurements of the production environment; and continuously receiving values of parameters of the production model.

In some implementations, the method further includes identifying the model deviation occurred by comparing the values of the parameters to a threshold value; and determining the model deviation occurred in response to the parameters exceeding the threshold value.

In some implementations, the method further includes receiving an indication that an anomaly occurred in the production environment; triggering the reinforcement machine learning model to modify the training parameters of the surrogate model in response to the anomaly occurring; receiving the calibration parameters identified by the reinforcement machine learning model that cause a reduction in the anomaly; and providing the calibration parameters.

In some implementations, the method further includes the anomaly is a different condition than an expected condition in the production environment.

In some implementations, the method further includes the surrogate model is a deep neural network machine learning model.

In some implementations, the method further includes the surrogate model is trained on parameters of the production model collected over time to learn a behavior of the production model in the production environment.

In some implementations, the method further includes presenting, on a display, the values for the calibration parameters and a confidence level of the values for reducing the model deviation.

In some implementations, the system includes a memory to store data and instructions; and a processor operable to communicate with the memory, wherein the processor is operable to: receive an indication that a model deviation occurred in a behavior of a production model running in a production environment; trigger, in response to the model deviation occurring, a reinforcement machine learning model to modify training parameters of a surrogate model that is a proxy of the production model; receive values for calibration parameters identified by the reinforcement machine learning model that cause a reduction in the model deviation, wherein the calibration parameters correspond to the modified training parameters of the surrogate model; and provide the calibration parameters to the production model.

In some implementations, a computer-readable storage medium including instructions that, when executed by a processor, cause the processor to: receive an indication that a model deviation occurred in a behavior of a production model running in a production environment; trigger, in response to the model deviation occurring, a reinforcement machine learning model to modify training parameters of a surrogate model that is a proxy of the production model; receive values for calibration parameters identified by the reinforcement machine learning model that cause a reduction in the model deviation, wherein the calibration parameters correspond to the modified training parameters of the surrogate model; and provide the calibration parameters to the production model.

The implementations of the wellbore extraction tool have been primarily described with reference to wellbore drilling operations; the wellbore extraction tool described herein may be used in applications other than the drilling of a wellbore. In other implementations, the wellbore extraction tool according to the present disclosure may be used outside a wellbore or other downhole environment used for the exploration or production of natural resources. For instance, the wellbore extraction tool of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific implementations of the present disclosure are described herein. These described implementations are examples of the presently disclosed techniques. Additionally, in an effort to provide a concise description of these implementations, not all features of an actual implementation may be described in the specification. It should be appreciated that in the development of any such actual implementation, as in any engineering or design project, numerous implementation-specific decisions will be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving an indication that a model deviation occurred in a behavior of a production model running in a production environment;
triggering, in response to the model deviation occurring, a reinforcement machine learning model to modify training parameters of a surrogate model that is a proxy of the production model;
receiving values for calibration parameters identified by the reinforcement machine learning model that cause a reduction in the model deviation, wherein the calibration parameters correspond to the modified training parameters of the surrogate model; and
providing the calibration parameters to the production model.

2. The method of claim 1, further comprising:
automatically modifying values of parameters of the production model to correspond to the values of the calibration parameters.

3. The method of claim 1, further comprising:
presenting, on a display, the calibration parameters for the production model; and
modifying the values of parameters of the production model in response to receiving a selection of the calibration parameters from a user.

4. The method of claim 1, further comprising:
continuously receiving real time field measurements of the production environment; and
continuously receiving values of parameters of the production model.

5. The method of claim 4, wherein identifying the model deviation occurred further includes:
comparing the values of the parameters to a threshold value; and
determining the model deviation occurred in response to the parameters exceeding the threshold value.

6. The method of claim 1, further comprising:
receiving an indication that an anomaly occurred in the production environment;
triggering the reinforcement machine learning model to modify the training parameters of the surrogate model in response to the anomaly occurring;
receiving the calibration parameters identified by the reinforcement machine learning model that cause a reduction in the anomaly; and
providing the calibration parameters.

7. The method of claim 6, wherein the anomaly is a different condition than an expected condition in the production environment.

8. The method of claim 1, wherein the surrogate model is a deep neural network machine learning model.

9. The method of claim 1, wherein the surrogate model is trained on parameters of the production model collected over time to learn a behavior of the production model in the production environment.

10. The method of claim 1, further comprising:
presenting, on a display, the values for the calibration parameters and a confidence level of the values for reducing the model deviation.

11. A system, comprising:
a memory to store data and instructions; and
a processor operable to communicate with the memory, wherein the processor is operable to:
receive an indication that a model deviation occurred in a behavior of a production model running in a production environment;
trigger, in response to the model deviation occurring, a reinforcement machine learning model to modify training parameters of a surrogate model that is a proxy of the production model;
receive values for calibration parameters identified by the reinforcement machine learning model that cause a reduction in the model deviation, wherein the calibration parameters correspond to the modified training parameters of the surrogate model; and
provide the calibration parameters to the production model.

12. The system of claim 11, wherein the processor is further operable to:
automatically modify values of parameters of the production model to correspond to the values of the calibration parameters.

13. The system of claim 11, wherein the processor is further operable to:
present, on a display, the calibration parameters for the production model; and
modify the values of parameters of the production model in response to receiving a selection of the calibration parameters from a user.

14. The system of claim 11, wherein the processor is further operable to:
continuously receive real time field measurements of the production environment; and
continuously receive values of parameters of the production model.

15. The system of claim 14, wherein the processor is further operable to identify the model deviation occurred by:
comparing the values of the parameters to a threshold value; and
determining the model deviation occurred in response to the parameters exceeding the threshold value.

16. The system of claim 11, wherein the processor is further operable to:
receive an indication that an anomaly occurred in the production environment;
trigger the reinforcement machine learning model to modify the training parameters of the surrogate model in response to the anomaly occurring;
receive the calibration parameters identified by the reinforcement machine learning model that cause a reduction in the anomaly; and
provide the calibration parameters.

17. The system of claim 16, wherein the anomaly is a different condition than an expected condition in the production environment.

18. The system of claim 11, wherein the surrogate model is a deep neural network machine learning model.

19. The system of claim 11, wherein the surrogate model is trained on parameters of the production model collected over time to learn a behavior of the production model in the production environment.

20. The system of claim 11, wherein the processor is further operable to:
present, on a display, the values for the calibration parameters and a confidence level of the values for reducing the model deviation.
